(19) United States
(12) Patent Application Publication
(10) Pub. No.: US 2005/0006326 A1
(43) Pub. Date: Jan. 13, 2005

(54) Article display hook

(76) Inventor: Borje Josefsson, Sundsvall (SE)

Correspondence Address: SUGHRUE MION, PLLC, 2100 PENNSYLVANIA AVENUE, N.W., SUITE 800, WASHINGTON, DC, 20037, US

(21) Appl. No.: 10/489,712

(22) PCT Filed: Sep. 19, 2002
(86) PCT No.: PCT/SE02/01696

(30) Foreign Application Priority Data
Sep. 20, 2001 (SE) 0103132-7

(51) Int. Cl. B42F 1/00

(52) U.S. Cl. 211/54.1

(57) ABSTRACT

Please add the following new Abstract of the Disclosure. Arrangement for product display prongs intended for displaying products in stores and the like. The arrangement includes a cantilever arm for carrying the products and a feed device which is displaceable along the arm and provided with a grip part. This device is intended, when acted on manually, to displace the products carried by the arm in the forward direction toward the free end thereof for the purpose of bringing about inter alia a favorable display of the products. The cantilever arm includes two essentially parallel wires which at their one ends are adapted for attachment to a supporting construction and the other, outer ends of which form the free end of the arm. The feed device includes a part which is intended for interaction with products carried by the wires and can be displaced along the wires, an elongate grip part connected thereto, which extends essentially parallel to and between the wires, and a guide element, fixed between the outer ends of the wires, for guiding the elongate grip part.

### FIELD OF THE INVENTION

The present invention relates to an arrangement for product display prongs intended for displaying products in stores and the like and which comprises a cantilever arm for carrying the products and a feed device which is displaceable along the arm and provided with a grip part and is intended, when acted on manually, to displace the products carried by the arm in the forward direction toward the free end thereof for the purpose of bringing about a favorable display of the products, and which cantilever arm comprises two essentially parallel wires which at their one ends are adapted for attachment to a supporting construction and the other, outer ends of which form the free end of the arm.

### BACKGROUND OF THE INVENTION

The majority of product display prongs of this type in use today suffer from the disadvantage that, when the products on the prong start to run out, it is difficult for the customer to find remaining products, as a number of prongs with different types of product are in most cases positioned close together. It has therefore long been desirable for the front product of the products carried by a prong always to be located as far forward on the prong as possible, even if there are only a few products on the prong.

It has previously been proposed to provide product prongs of this type with a manually operated feed device which can run along the prong. In order for it to be possible for this to be taken hold of, it has usually been provided with an upwardly, forwardly projecting grip part. Such grip parts can, however, constitute an obstruction for products on, for example, prongs located above and limit inter alia the minimum possible spacing between prongs located one above another.

In order to overcome inter alia this problem, spring-operated feed devices which do not have to be operated manually have been proposed. However, such feed devices are more complicated and more expensive to manufacture and assemble as they consist of several components. They can also be difficult to use for some types of product, such as bags containing loose material.

### THE OBJECT OF THE INVENTION

One object of the present invention is to produce a manual feed device for products on wire prongs, which inter alia eliminates the abovementioned disadvantages of previously known arrangements of this type.

The invention is based on the realization that this object can be achieved if the feed device is provided with a grip part which, in the rest position, that is to say when no feeding operation is being performed, does not project from the prong in any direction, but which, for feeding, is simple to take hold of.

In this connection, it is particularly characteristic of an arrangement of the type indicated in the first paragraph that the feed device comprises a part which is intended for interaction with products carried by the wires and can be displaced along the wires, an elongate grip part connected thereto, which extends essentially parallel to and between the wires, and a guide element, fixed between the outer ends of the wires, for guiding the elongate grip part.

An arrangement of this type achieves inter alia the abovementioned object of, in the rest position, not constituting an obstruction for products on the prong or on adjacent prongs and thus does not limit how closely the prongs can be positioned.

It is preferred that the guide element is made with a guide groove or a through opening for guiding the grip part. When the wire prong is U-shaped with an upwardly angled end portion, the guide element suitably has an angle corresponding to the angle of the wires, the guide groove or guide opening of the grip part extending essentially parallel to the direction of the main part of the wires. The guide element can then be fastened between the outer portions of the wires.

The grip part is suitably made in such a way that its outer end is located in a protected manner under a part joining the outer ends of the wires, when the feed device is located in a pushed-in rest position.

Other features of the invention emerge from the following patent claims.

The invention will be described in greater detail below with reference to the embodiment shown by way of example in the accompanying drawings.

### BRIEF DESCRIPTION OF THE DRAWING FIGURES

FIG. 1 shows a perspective view of a product display prong with a feed device according to the invention in rest position.

FIG. 2 is a longitudinal cross section through the product prong according to FIG. 1.

FIG. 3 shows the product prong according to FIG. 1 with the feed device in the pulled-out position.

FIG. 4 is a longitudinal section through the product prong according to FIG. 3.

### DETAILED DESCRIPTION OF THE REFERRED EMBODIMENT

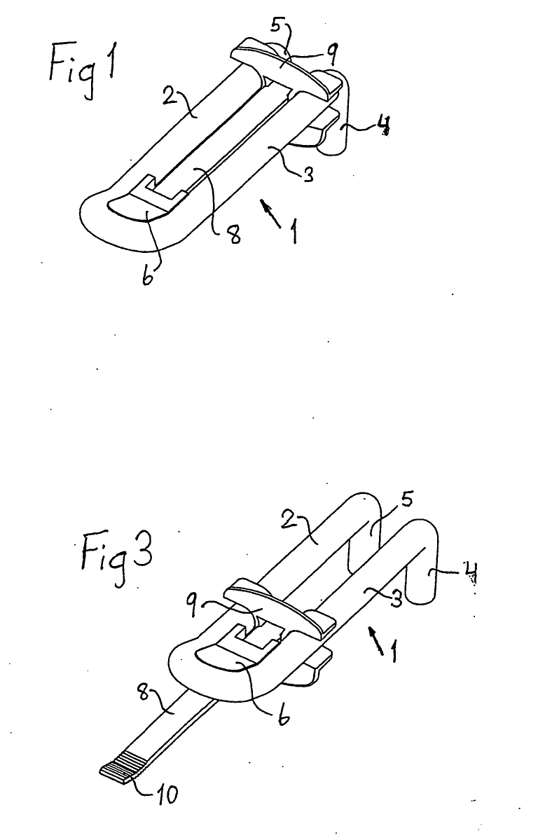

In FIG. 1, reference number 1 designates a product display prong consisting of two wires 2, 3 which are joined at the outer end of the prong to form a U-shaped product prong. The rear end portions 4, 5 of the wires are intended to be provided with some type of known mounting element for mounting on a supporting construction, for example in the form of a plate provided with holes.

The prong shown is made in the form of a bent wire. It can just as well consist of two separate wires, the outer ends of which are either free or interconnected. The wires 2 and 3 can also be replaced by other supporting elements of any cross section. As an alternative to being located in a common horizontal plane, the wires or equivalent elements can be located in a common vertical plane.

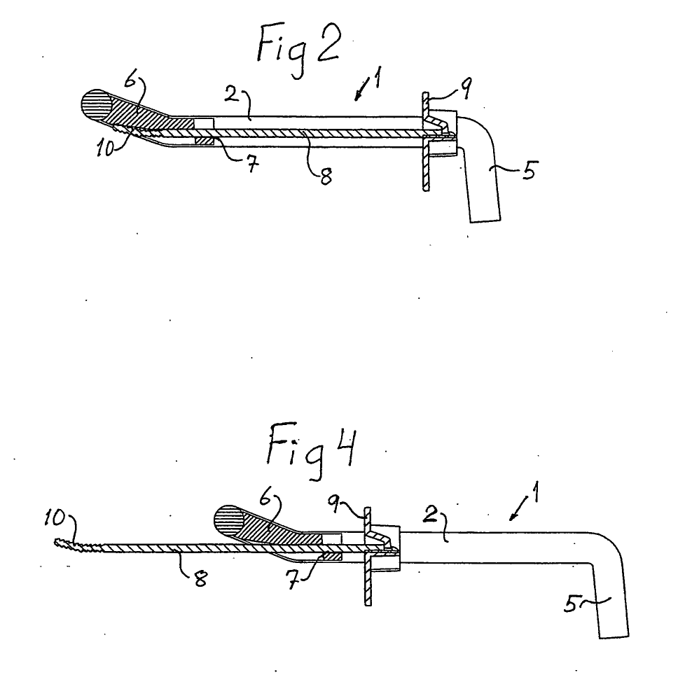

At the outer ends of the wires 2 and 3, a guide element 6 is arranged, in the case shown by being pressed firmly between the wires. In the embodiment shown, this guide element is made with a through opening 7 (see FIGS. 2 and 4) for passage and guidance of an elongate grip part 8. As an alternative to an opening 7, the guide element 6 can be made with an open guide groove for the grip part 8.

The grip part 8 is, at its inner end, connected to a feed plate 9 and, together with this, forms a feed device for products (not shown) which are carried on the prong 1.

The front end of the grip part 8 is made in the form of a thumb grip 10 which is shaped so as to be easy to take hold of and so that, in the rest position of the feed device according to FIGS. 1 and 2, it lies in a protected manner under the guide element 6, so that it does not hinder the removal of products from or the arrangement of products on this prong or prongs located above or below it.

The feed device consisting of the grip part 8 with its thumb grip 10 and feed plate 9 requires no extra space as the grip part 8 extends between the wires 2 and 3. When it is necessary to feed products carried by the prong toward its front end, it is easy, by means of the thumb grip 10, to pull out the grip part 8 with the feed plate 9 toward the position shown in FIGS. 3 and 4 depending on the quantity of products on the prong.

In the case of the prong with an upwardly angled outer portion shown in the drawings, the guide element 6 is also made in the form of a correspondingly angled element. This means that the opening 7 or a corresponding guide groove in the guide element 6 can extend essentially horizontally and in the same plane as the main part of the grip part 8 located between the wires 2 and 3. This simplifies both manufacture and use of the arrangement.

The invention has been described above in connection with the embodiment shown in the drawings. However, it can be varied with regard to various details within the following patent claims. The invention can therefore be applied to prongs with a shape other than that shown by virtue of the design of the guide element 6 being adapted to the shape of the prong concerned. Other variations are also possible while retaining the advantage of a grip part located between the wires of the prong or equivalent.

1. An arrangement for product display prongs intended for displaying products in stores and the like and which comprises a cantilever arm for carrying the products and a feed device which is displaceable along the arm and provided with a grip part and is intended, when acted on manually, to displace the products carried by the arm in the forward direction toward the free end thereof for the purpose of bringing about a favorable display of the products, and which cantilever arm comprises two essentially parallel wires which at their one ends are adapted for attachment to a supporting construction and the other, outer ends of which form the free end of the arm the feed device comprising a part which is intended for interaction with products carried by the wires and can be displaced along the wires, and an elongate grip part connected thereto, wherein the grip part extends essentially parallel to and between the wires, and wherein the arrangement comprises a guide element, fixed between the outer ends of the wires, for guiding the elongate grip part.

2. The arrangement as claimed in claim 1, wherein said guide element is made with a through guide opening or a guide groove for guiding said grip part.

3. The arrangement as claimed in claim 2, intended for an essentially U-shaped wire prong with an upwardly angled end portion, wherein said guide element has an angle corresponding to the angle of the wires and in that the guide groove or guide opening of the grip part extends essentially parallel to the direction of the main part of the wires.

4. The arrangement as claimed in claim 1, wherein said guide element is fastened between the outer portions of the wires.

5. The arrangement as claimed in claim 1, wherein the outer end of said grip part is located in a protected manner under a part joining the outer ends of the wires, when the part intended for interaction with products carried by the wires is located in an inner end position.

6. The arrangement as claimed in claim 1, wherein said grip part extends in a protected manner in a space formed between the wires.

7. The arrangement as claimed in claim 6, wherein, from said space between the wires, the grip part extends through an opening in said guide element, which is located in a common plane with that part of the grip part which is located between the wires.
